(19) United States
(12) Patent Application Publication
(10) Pub. No.: US 2019/0384006 A1
(43) Pub. Date: Dec. 19, 2019

(54) SYSTEMS AND METHODS FOR REDUCED END-FACE REFLECTION BACK-COUPLING IN FIBER-OPTICS

(71) Applicant: Vanderbilt University, Nashville, TN (US)

(72) Inventors: Yuankai Tao, Nashville, TN (US); Mohamed T. El-Haddad, Nashville, TN (US); Joseph D. Malone, Nashville, TN (US)

(21) Appl. No.: 16/481,227

(22) PCT Filed: Jan. 26, 2018
(86) PCT No.: PCT/US2018/015531

§ 371 Date: Jul. 26, 2019

Related U.S. Application Data
(60) Provisional application No. 62/451,315, filed on Jan. 27, 2017.

(51) Int. Cl. G02B 6/26; G02B 6/036; G02B 6/032; G02B 6/255; G02B 6/34

(52) U.S. Cl. CPC G02B 6/262; G02B 6/036; G02B 6/34; G02B 6/2551; G02B 6/032

(57) ABSTRACT

Fiber optic methods and systems angularly and spatially offset back reflections away from numerical apertures of a core and inner cladding of a double-clad fiber (DCF) that transmits light to downstream optical interfaces. Back reflections from near and/or far downstream optical interfaces are offset away from the numerical aperture of the core and inner cladding by (1) adjusting an axial length between the DCF end face and the near and/or far reflective optical interfaces, and (2) angling the near and/or the far optical interfaces to angularly and spatially displace back reflections away from the core and inner cladding. No-core fiber fusion spliced to the DCF, or a wedge prism attached to the DCF by index matched gel may be used to adjust the axial lengths and angled the reflections.

### CROSS-REFERENCE TO RELATED APPLICATIONS

This application is a non-provisional of and claims the benefit of priority to U.S. Provisional Patent Application No. 62/451,315, filed on Jan. 27, 2017, which is incorporated herein by reference in its entirety.

### BACKGROUND OF THE INVENTION

Fiber end-face back-reflection is a significant source of noise in fiber-optic systems. The reflection is a result of a refractive index discontinuity between the fiber core and either air or another optical material at the interface between fiber-optic relays. In the case of single-mode and multi-mode fibers (SMF and MMF, respectively), this end-face reflection directly couples a few percent of the incident light directly back to the source. When optically coupled to either the source or detector, these reflections may permanently damage optical components or limit detection sensitivity.

For double-clad fibers (DCFs), the end-face reflection from the core may be optically coupled to both the single-mode core and multi-mode inner cladding. The problem of interface reflections may also be extended beyond those arising from the polished fiber end-face to any reflective or partially reflective optical surfaces downstream from the fiber. These spurious reflections may affect all fiber-optic components including aforementioned SMF, MMF, DCF, and fiber bundle configurations.

The potential impact of fiber end-face back-reflection may be significant for both optical signal generation and detection. Light coupled back to the source may have deleterious effects on laser diodes and free-space cavities that result in permanent damage to gain media, cavity optics, or optomechanics. Similarly, in detection, back-reflections are a potential source of significant background noise. While this signal background may be removed using computational approaches, these methods are only suitable for temporally stable signals and do not compensate for the dynamic range occupied by the reflected background.

Current approaches for suppressing these reflections, such as angle-polishing the fiber-face, only work for a small subset of fiber-optical components. The development of angled physical contact (APC) connectors for SMF has reduced the effect of back-reflections with industry standard connector return losses on the order of −60 dB. This is accomplished by angle-polishing the fiber end-face to 8-degrees such that most reflections are outside of the numerical aperture (NA) of the fiber and not propagated, While APC connectors may also be used with MMF, the return losses are several orders of magnitude lower (−10 dB for low-NA fibers) because of the large acceptance angle of these fibers. Similarly, the utility of APC connectors is also limited when used with high-NA SMFs and DCFs.

### SUMMARY OF THE INVENTION

Conventional methods angularly offset end-face back-reflection and are limited to fibers with low numerical aperture, which are only a subset of single-mode and multi-mode fibers. However, embodiments of the methods and systems described herein, both angularly and spatially offset reflections outside of the acceptance angle and the face of the fiber-optic, and are broadly applicable.

Angled physical contact is the industry standard for minimizing fiber end-face reflections, but only works for low-NA fibers. Embodiments of the methods described herein work for a broad range of fibers and have improvements over APC

In some embodiments, a fiber optic system is provided for spatially offset end-face reflections. The fiber optic system includes a double-clad fiber segment comprising a core and inner cladding that is configured to receive an incident beam at an upstream end of the double-clad fiber segment and emit a beam at a downstream end of the double-clad fiber segment. A no-core fiber segment that is fusion spliced to the downstream end of the double clad fiber segment transmits the beam emitted by the double-clad fiber segment downstream to a downstream end of the no-core fiber segment. The no-core fiber segment also transmits a reflection of the beam from the downstream end of the no-core fiber segment. A face of the no-core fiber segment downstream end has a polished angle and an axial length that are configured such that the reflected beam is angularly steered and spatially displaced relative to the core and the inner cladding of the double-clad fiber segment.

In some embodiments, a method is provided for spatially offsetting end-face reflections. The method includes configuring a no-core fiber segment to have a specified axial length and a specified polished angle face at a downstream end of the no-core fiber segment. A double-clad fiber segment is fusion spliced to the no-core fiber segment. The double-clad fiber segment comprises a core and an inner cladding and is configured to receive an incident beam at an upstream end and emit a beam at a downstream end of the double-clad fiber segment. The no-core fiber segment transmits the beam emitted by the double-clad fiber segment downstream to the downstream end of the no-core fiber segment and transmits a reflection of the beam from the polished angle face at the downstream end of the no-core fiber segment. The specified axial length and the polished angle face at the downstream end of the no-core fiber segment are configured such that the reflected beam is angularly steered and spatially displaced relative to the core and the inner cladding of the double-clad fiber segment.

In some embodiments, a system includes an optical fiber disposed adjacent to a wedge prism. The wedge prism has a close end face adjacent to the optical fiber and a far end face. The optical fiber has an angle-polished end face that is displaced by an axial length from the close end face of the wedge prism. A beam of light is output from the optical fiber and reflections from the close end face of the wedge prism are spatially offset from the inner cladding or core of the optical fiber.

In some embodiments, a method includes transmitting a beam of light, by a wedge prism, which is received from an optical fiber disposed adjacent to the wedge prism. The wedge prism has a close end face adjacent to the optical fiber and a far end face. The optical fiber has an angle-polished end face that is displaced by an axial length from the close end face of the wedge prism. Reflections of the beam of light from the close end face of the wedge prism are spatially offset from the inner cladding or core of the optical fiber.

Embodiments of the present invention may be utilized in products and applications related, but not limited, to telecom relays, fiber laser systems, and fiber-optic imaging systems including endoscopes.

Other aspects of the invention will become apparent by consideration of the detailed description and accompanying drawings.

### BRIEF DESCRIPTION OF THE DRAWINGS

FIG. 1A schematically illustrates a double-clad fiber with an angle polished end-face that shows reflections of a core beam that optically couple to both of the core and the inner cladding.

FIG. 1B schematically illustrates a double-clad fiber with a flat-polished end-face that shows reflections from core beam that optically couple to both of the core and inner cladding.

FIG. 1C schematically illustrates a flat-polished DCF that is index-matched to a short wedge prism and shows reflection coupling from both of the front and back faces of the wedge prism.

FIG. 1D schematically illustrates that extending the length of the wedge prism spatially offsets reflections from the back-face of the wedge prism

FIG. 1E schematically illustrates an optimal angle-polished DCF physically coupled to a wedge prism and shows a configuration with minimal back-reflection coupling.

FIG. 2 graphically illustrates a comparison of return losses from multiple DCF coupling schemes.

FIG. 3 illustrates a simulated offset back reflection from back end face of a fusion spliced no-core fiber having a specified axial length and a polished angled back end face.

FIG. 4 graphically illustrates a comparison of return losses from DCF termination schemes.

### DETAILED DESCRIPTION

Before any embodiments of the invention are explained in detail, it is to be understood that the invention is not limited in its application to the details of construction and the arrangement of components set forth in the following description or illustrated in the following drawings, The invention is capable of other embodiments and of being practiced or of being carried out in various ways.

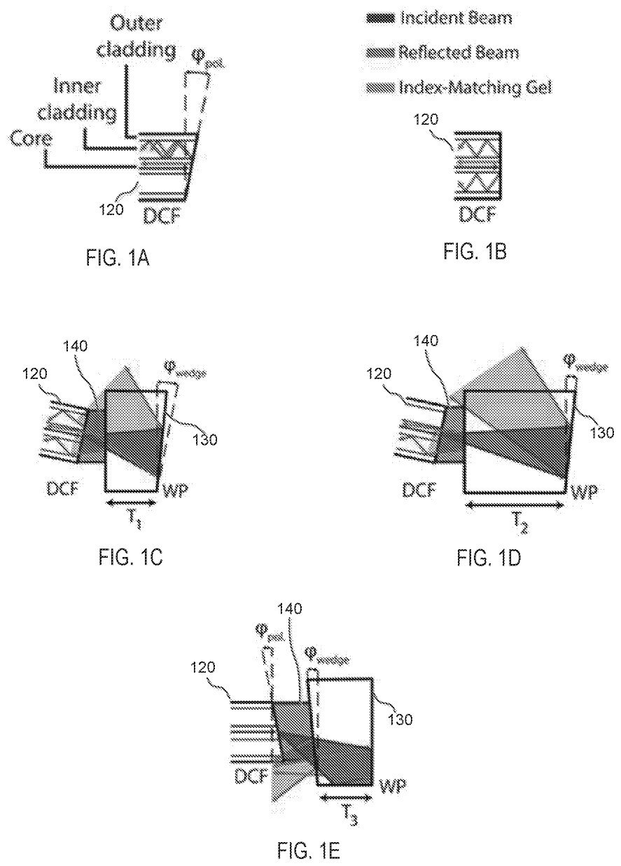

FIG. 1A schematically illustrates a double-clad fiber with an angle polished end-face that shows reflections of a core beam that optically couple to both of the core and the inner cladding. FIG. 1B schematically illustrates a double-clad fiber with a flat-polished end-face that shows reflections from core beam that optically couple to both of the core and inner cladding. A common operational mode for double clad fiber (DCF) is to relay source light through the single-mode core and couple or detect through the multi-mode inner cladding. As shown in FIG. 1A, angle-polishing, while suppressing reflection back-coupling into the core, increases reflections coupled into the inner cladding. Therefore, flat-polishing is preferred. Methods and systems are provided to suppress fiber end-face reflections in high numerical aperture (NA) fibers, for example, SMF, MMF, DCF, fiber bundles, and most fiber-optic components, by both of (1) angling back-reflections outside the acceptance NA of the fiber and (2) spatially offsetting any reflections to minimize back-coupling.

FIGS. 1C-1E illustrate various configurations of a double clad fiber 20 attached by an index-matching gel 140 to a wedge prism 130, according to various embodiments.

FIG. 1C schematically illustrates a flat-polished DCF 120 that is index-matched to a short wedge prism 130 with the index-matching gel 140. Referring to FIG. 1C, a non-optimal configuration is shown as an intermediate solution. Reflections from both of the front and back faces of the wedge prism 130 are optically coupled into the core and inner cladding of the DCF 120. The flat-polished fiber 120 is angled relative to and index-matched to the front face of the short wedge prism 130. The DCF 120 angle relative to the prism 130 front face reduces some residual back-reflection coupling from that front surface, which results from imperfect index-matching. The thickness and the back-face angle of the wedge prism act to angularly and spatially offset the dominant glass-to-air interface reflection in the system. In FIG. 1C, the thickness, or axial length of the wedge prism 130 is insufficient to fully offset the back-face reflection from the inner cladding of the DCF.

FIG. 1D schematically illustrates that by extending the axial length or thickness of the wedge prism 130, reflections from the back-face of the wedge prism 130 are spatially offset. By extending the axial length or thickness of the wedge prism 130, the wedge prism 130 back-face reflection may he completely offset from the inner cladding of the DCF and suppressed, leaving only reflections from the front face of the wedge prism 130. Back reflection coupling is reduced relative to the example shown in FIG. 1C. For example, a reduction in hack reflection coupling is shown in the inner cladding of the DCF 120.

FIG. 1E schematically illustrates an improved or optimal configuration. Referring to FIG. 1E an optimal or improved configuration of angle-polished DCF 120 physically coupled to a wedge prism 130 shows further reduced back-reflection coupling. An angle-polished DCF 120 is attached by index-matching gel 140 to the wedge prism 130 with minimal back-reflection optical coupling in the DCF 130. A polished angle end of the DCF 120 and/or an end angle of the wedge prism 130 serve to steer back reflections while the extent of the axial length of the wedge prism 130 serves to spatially offset the hack reflection such that the hack reflection falls outside of the numerical aperture of the core and numerical aperture of the inner cladding of the DCF 120.

In the embodiments described with respect to FIGS. 1C-1E, off-the-shelf wedge prisms 130 are attached to the DCF 120 by index-matching gel 140. The length of the wedge prisms 130 are used to spatially offset and angle the back-reflections to prevent or reduce back coupling in the DCF 120 core and inner cladding. However, these methods and systems may be similarly extended to fusion-splicing no-core fibers or index-matched polished substrates directly to fibers.

Various parameters may he taken into consideration when designing a system including a DCF 120, and wedge prism 130 attached to the DCF 120 by index-matching gel 140 for angularly and spatially offsetting back reflections away from the core and/or inner cladding of the DCF 120, as described with respect to FIGS. 1A-1E.

In some embodiments, the DCF 120 end-face may be polished at an angle and displaced by an axial length from the closer face of the wedge prism 130 such that light exiting the DCF 120 and reflections from this closer wedge prism face are spatially offset from the DCF inner cladding or core. These polish angle and axial length values may scale based on the refractive index difference between the DCF 120 and index-matching gel. The axial length is inversely proportional to the polish angle of the DCF 120 end-face and proportional to the NA of the DCF.

In some embodiments, the wedge prism 130 face is closer to the DCF 120 end-face is polished at an angle such that light exiting the DCF 120 and reflections from this wedge prism 130 face are spatially offset from the DCF 120 inner cladding or core. These polish angle values may scale based on the refractive index difference between the DCF 120 and the wedge prism 130.

In some embodiments, the wedge prism 130 axial length and the length between the DCF end face and the close face of the wedge prism are set such that reflections from the prism-to-air interface are spatially offset away from the DCF 120 inner cladding or core. These axial length values scale based on the polish angle of the DCF end face and refractive index difference between the DCF 120 and the wedge prism 130.

In some embodiments, the wedge prism 130 diameter is set such that the light exiting the DCF 120 and propagating through the wedge prism 130 does not intersect the circumference of the wedge prism 130. The diameter value scales based on the refractive index difference between the DCF 120 and the wedge prism 130.

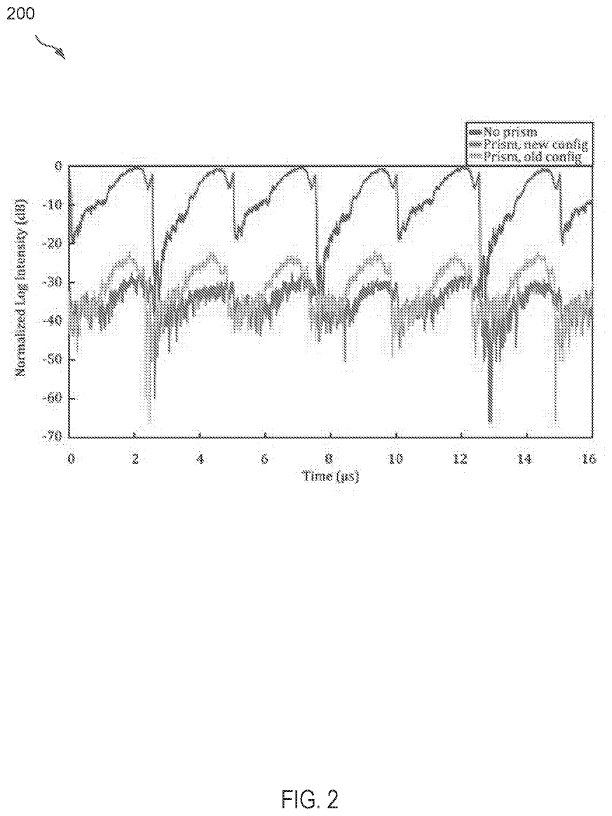

FIG. 2 graphically illustrates a comparison of return losses from DCF optical coupling schemes. All return losses are shown relative to the flat-polished DCF 120 case described with respect to FIG. 1B (no prism). By physically coupling a flat-polished DCF 120 to a wedge prism 130 as shown in FIG. 1D yields approximately −25 dB (old configuration) reduction in return loss. An improved or optimal physical coupling of an angle-polished DCF 120 to wedge prism 130 as described with respect to FIG. 1E, improves return loss to −30 dB (new configuration). In the preliminary results, a −25 dB return loss (FIG. 1D) was measured as compared to the flat-polished free-space configuration (FIG. 1B). To further suppress reflections, an angle-polished DCF 120 is index-matched to the angled face of a wedge prism (FIG. 1E). Both the front face and back face reflections are angularly and spatially offset from the wedge prism and improve return losses to −30 dB (FIG. 1E).

The configurations in FIGS. 1C-1E are compact and do not significantly alter the specifications of a fiber-optical component. The reflective output from the wedge prism 130 is both angularly and spatially offset from the DCF 120 optical axis, but can be easily compensated using custom optomechanics. When implemented using fusion splicing, these offsets may be compensated for in components spliced to the DCF 120. Return loss performance may improve with optimized index-matching. This methods and systems described herein are broadly applicable for removing fiber end-face reflections in fiber-optical components that do not benefit from standard APC connectorization.

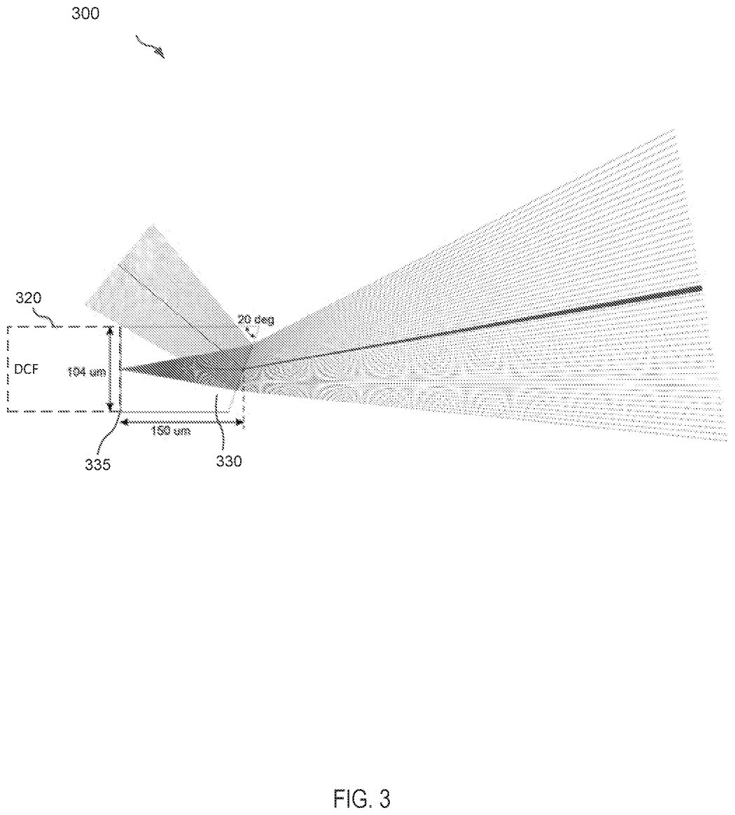

FIG. 3 illustrates a simulated offset back reflection from back end face of a fusion spliced no-core fiber (NCF) having a specified axial length and a polished angled back end face. FIGS. 1C-1E demonstrated a method and system for reducing or removing end-face back-reflection optical coupling in DCFs using an index-matched wedge prism 130. In some embodiments, the wedge prism solution may be physically bulky and back-coupling mitigation efficacy may degrade over time as the coupling gel 140 dehydrates. A more streamlined and durable approach includes the aforementioned NCF or index-matched polished substrates directly fusion-spliced to DCF fibers. A no-core fiber comprises a cylinder of fiber without an inner core or inner cladding that has a refractive index that closely matches the core index of the DCF fiber. The fusion spliced elements improve system stability and eliminate the need for physical optical components.

Referring to FIG. 3, a fiber optic system configuration 300 includes a flat polished DCF segment 320 that is fusion spliced to a NCF segment 330. The front end face 335 of the NCF segment 330 is fusion spliced to the DCF segment 320. Parameters for an NCF 330 axial length and back end polish angle are provided based on a simulation. A simulated ray trace is shown as output from the DCF 320 and entering the NCF 330 from the left side 335 of the NCF 330.

In the simulation, the DCF 320 has a 104 um inner cladding diameter and multimode numerical aperture of 0.26. The output light is simulated based on the multimode inner cladding numerical aperture instead of a single mode core numerical aperture under the assumption that there will be some appreciable light leakage into the multimode inner cladding during transmission or reflection coupling in the DCF 320.

In general, an NCF axial length has a lower bound that is limited by the maximum NCF end-face polish angle that may be accommodated by a downstream optical system. For example, an NCF 330 end-face polish angle increases as an NCF 330 axial length decreases. The upper bound on an NCF 330 axial length is determined based on the numerical aperture of the DCF 320 as the light source to the NCF 330, and is limited by the outer edge of the NCF 330 diameter. Any rays that extend past this diameter will be clipped, thus reducing optical throughput and resulting in output point spread function (PSF) asymmetry.

The configuration 300 shows how all of the NCF 330 back end face back-reflections may be spatially offset from the multimode inner cladding of the DCF 320. The DCF 320 is fused spliced to the NCF 330. The simulation includes a transmission beam and an end-face back-reflection for optimizing the axial length and the polish angle of a NCF 330, Simulation parameters include a multimode inner cladding diameter of 104 um for the DCF 320. The NCF 330 back end face polish angle was optimized for an NCF 330 axial length of 150 um in the simulation. The polish angle is set at 20° to spatially offset the end-face reflections away from the multimode inner cladding of the DCF 320 through the 150 um axial length of NCF 330. The NCF 330 length and polish angle may be adjusted within a range such that the downstream transmitted light does not clip the diameter of the NCF 320. The diameter of the NCF 320 was set at ˜250 um for a simulated numerical aperture NA=0.26 of the DCF 320. In the simulation, the reflection is completely offset from the 104 um inner cladding of the DCF 320.

Various parameters may be taken into consideration when designing a system including a DCF 320, and NCF 330 that is fusion spliced to the DCF 320 for angularly and spatially offsetting back reflections away from the core and/or inner cladding of the DCF 320, as described with respect to FIG. 3.

In some embodiments, NCF 330 axial length and polish angle are set such that reflections from the no-core fiber-to-air interface are spatially offset away from the DCF 320 inner cladding or core. These axial length and polish angle values scale based on the refractive index difference between the DCF 320 and NCF 330.

In some embodiments, NCF 330 diameter is set such that the light exiting the DCF 320 and propagating through the NCF 330 do not intersect the circumference of the NCF 330. The diameter value may scale based on the refractive index difference between the DCF and the NCF.

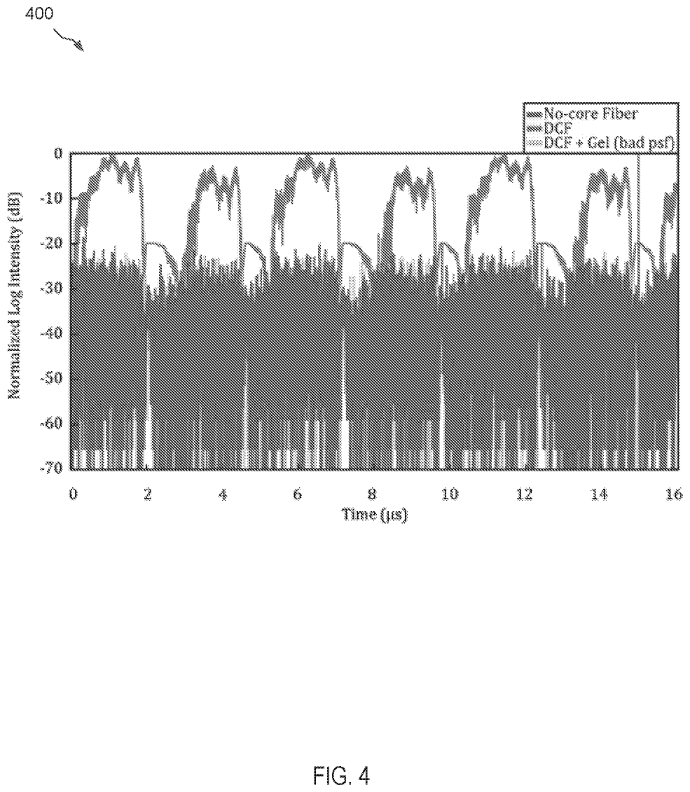

FIG. 4 graphically illustrates a comparison of back coupling power measurements for multiple DCF termination schemes. Referring to FIG. 4, return losses are shown relative to the flat-polished DCF 120 labeled DCF and described with respect to FIG. 1B. The return loss based on terminating a flat-polished DCF 320 with a NCF 330 is labeled no-core fiber, and the return loss based on terminating a DCF 120 with an index matching gel 140 and wedge prism 130 is labeled DCF and Gel. The return losses may reduce end-face back-coupling in the DCF by 25-30 dB.

Referring to FIG. 4, back-coupling power measurements are compared for the fusion spliced NCF 330 scheme from FIG. 3, with the conventional flat-polished DCF termination of FIG. 1B, and the DCF 120 and wedge prism 130 configuration including index gel 140 at the interface of the DCF 120 and wedge prism 130. Back-coupling power measurements for the NCF 330 termination embodiment achieves a −25 to −30 dB reduction in end-face reflection back-coupling as compared to the flat-polished DCF termination (DCF). While back coupling power measurements for DCF 120 with the dab of coupling gel 140 at the end-face interfaces achieves a similar performance when simulating a maximum expected back-coupling reduction.

With respect to the DCF and gel approach, the resultant point spread function is significantly aberrated as a result of random phase errors from the uneven gel surface. Furthermore, the NCF 330 approach is robust to dehydration over time and may be combined with a standard termination ferrule to reduce risk of breakage and enable simple coupling to other fiber optics and fiber-to-free space optics and optomechanics.

The method and system described herein provides back reflection mitigation in a core and inner cladding of DCF. The method and system can easily be modified depending on the fiber optic termination restrictions. A DCF and wedge prism having a specified axial length and/or end face angle are attached by an index matching gel for angularly steering and spatially distancing back reflections away from a core and inner cladding of the DCF. Also, a DCF and fusion spliced NCF having a specified axial length and far end polished angle angularly steer and spatially distance back reflections away from a core and inner cladding of the DCF,

In some embodiments, a fiber optic is positioned adjacent to a wedge prism, the fiber optic having a longitudinal axis and an angle-polished face, the wedge prism having a front angled face. a beam of light is output from the fiber optic. Reflections of the light beam are angularly and spatially offset from inner-cladding of the fiber optic. The angle-polished face is oriented at an angle of 82 degrees with respect to the longitudinal axis. The front angled face of the wedge prism is oriented at an angle of 78 degrees 38 minutes with respect to the longitudinal axis. The wedge prism defines a thickness of greater than 5.34 mm at the center of the wedge prism. The wedge prism includes a back face, and further, the back face is oriented at 90 degrees relative to the longitudinal axis. Losses from the reflections are improved at least by −30 dB or losses from the reflections are improved by at least by −25 dB.

Although the invention has been described in detail with reference to certain preferred embodiments, variations and modifications exist within the scope and spirit of one or more independent aspects of the invention as described.

1. A fiber optic system for spatially offsetting end-face reflections, the system comprising:
a double-clad fiber segment comprising a core and inner cladding, the double clad fiber segment configured to receive an incident beam at an upstream end of the double-clad fiber segment and emit a beam at a downstream end of the double-clad fiber segment; and
a no-core fiber segment that is fusion spliced to the downstream end of the double clad fiber segment, wherein:
the no-core fiber segment transmits the beam emitted by the double-clad fiber segment downstream to a downstream end of the no-core fiber segment, and transmits a reflection of the beam from the downstream end of the no-core fiber segment, and
a face of the no-core fiber segment downstream end has a polished angle and an axial length that are configured such that the reflected beam is angularly steered and spatially displaced relative to the core and the inner cladding of the double-clad fiber segment.

2. The system claim 1, wherein the reflected beam is optically uncoupled from the core and the inner cladding of the double-clad fiber segment by the configuration of the downstream face polished angle of the no-core fiber segment and the axial length of the no-core fiber segment.

3. The system claim 1, wherein the downstream face polished angle and the axial length of the no-core fiber segment are scalable based on a difference between a refractive index of the double-core fiber segment and a refractive index of the no-core fiber.

4. The system claim 1, wherein a diameter of the no-core fiber segment is:
configured such that the beam emitted by the double-core fiber segment and transmitted through the no-core fiber segment do not intersect the circumference of the no-core fiber segment; and
scalable based on a difference between a refractive index of the double-core fiber segment and a refractive index of the no-core fiber segment.

5. The system claim 1, wherein the double-clad fiber segment has a flat polished downstream end face.

6. The system of claim 1, wherein the axial length of the no-core fiber segment depends on an angle of the downstream face polished angle of the no-core fiber segment.

7. The system of claim 1, wherein the axial length of the no-core fiber segment depends on a numerical aperture of the core of the double-clad fiber segment and a numerical aperture of the inner cladding of the double-clad fiber segment.

8. The system of claim 1, wherein the axial length of the no-core fiber segment depends on an outer edge diameter of the double-clad fiber segment.

9. The system of claim 1, wherein an amount of the reflected beam from the downstream end of the no-core fiber segment that couples the core and the inner cladding of the double-clad fiber segment depends on the axial length of the no-core fiber segment, an angle of the downstream face polished angle of the no-core fiber segment, a numerical aperture of the core of the double-clad fiber segment, a numerical aperture of the inner cladding of the double-core fiber segment, and an outer edge diameter of the double-clad fiber segment.

10. A method for spatially offsetting end-face reflections, the method comprising: configuring a no-core fiber segment to have a specified axial length and a specified polished angle face at a downstream end of the no-core fiber segment;
fusion splicing a double-clad fiber segment to the no-core fiber segment, wherein:
the double-clad fiber segment comprises a core and an inner cladding and is configured to receive an incident beam at an upstream end and emit a beam at a downstream end of the double-clad fiber segment; wherein:
the no-core fiber segment transmits the beam emitted by the double-clad fiber segment downstream to the downstream end of the no-core fiber segment, and transmits a reflection of the beam from the polished angle face at the downstream end of the no-core fiber segment; and
the specified axial length and the polished angle face at the downstream end of the no-core fiber segment are configured such that the reflected beam is angularly steered and spatially displaced relative to the core and the inner cladding of the double-clad fiber segment.

11. The method of claim 10, wherein the reflected beam is optically uncoupled from the core and the inner cladding of the double-clad fiber segment by the configuration of the downstream face polished angle of the no-core fiber segment and the axial length of the no-core fiber segment.

12. The method claim 10, wherein the downstream face polished angle and the axial length of the no-core fiber segment are scaled based on a difference between a refractive index of the double-core fiber segment and a refractive index of the no-core fiber.

13. The method claim 10, wherein a diameter of the no-core fiber segment is:
configured such that the beam emitted by the double-core fiber segment and transmitted through the no-core fiber segment do not intersect the circumference of the no-core fiber segment; and
scaled based on a difference between a refractive index of the double-core fiber segment and a refractive index of the no-core fiber segment.

14. The method claim 10, wherein the double-clad fiber segment has a flat polished downstream end face.

15. The method of claim 10, wherein the axial length of the no-core fiber segment depends on an angle of the downstream end face polished angle of the no-core fiber segment.

16. The method of claim 10, wherein the axial length of the no-core fiber segment depends on:
a numerical aperture of the core of the double-clad fiber segment; and
a numerical aperture of the inner cladding of the double-clad fiber segment.

17. The method of claim 10, wherein the axial length of the no-core fiber segment depends on an outer edge diameter of the double-clad fiber segment.

18. The method of claim 10, wherein an amount of the reflected beam from the downstream end of the no-core fiber segment that couples the core and the inner cladding of the double-clad fiber segment depends on the axial length of the no-core fiber segment, the angle of the downstream end face of the no-core fiber segment, a numerical aperture of the core of the double-clad fiber segment, a numerical aperture of the inner cladding of the double-core fiber segment, and an outer edge diameter of the double-clad fiber segment.

19-27. (canceled)
